(19) United States
(12) Patent Application Publication
(10) Pub. No.: US 2006/0053893 A1
(43) Pub. Date: Mar. 16, 2006

(54) Pressure measuring unit

(76) Inventors: Karl-Heinz Banholzer, Aachen (DE); Bernd Rosskopf, Hausen (DE)

Correspondence Address: BACON & THOMAS, PLLC, 625 SLATERS LANE, FOURTH FLOOR, ALEXANDRIA, VA, 22314, US

(21) Appl. No.: 10/517,307

(22) PCT Filed: Jun. 16, 2003
(86) PCT No.: PCT/EP03/06311

§ 371 Date: Aug. 22, 2005

(30) Foreign Application Priority Data
Jun. 19, 2002 (DE) 102 27 479.7

(51) Int. Cl. G01L 7/08

(52) U.S. Cl. 73/715

(57) ABSTRACT

A pressure measuring unit is provided, which is as universally usable as possible. The pressure measuring unit includes a ceramic pressure sensor held in a metal housing. Surfaces of the housing coming during measurement in contact with a medium, whose pressure is to be measured, are provided with a coating of enamel or a glassy material.

The invention relates to a pressure-measuring unit.

In the technology of the measurement of pressure, absolute, relative and differential pressure sensors are used. With absolute pressure sensors, a pressure to be measured is registered absolutely, i.e. as a pressure difference relative to vacuum. In the case of a relative pressure sensor, a pressure to be measured is sensed in the form of a pressure difference relative to a reference pressure, e.g. some pressure existing at the location of the sensor. In most applications, this is the atmospheric pressure at the site where the sensor is being used. Thus, in the case of the absolute pressure sensor, a pressure to be measured is registered referenced to a fixed reference pressure, i.e. the pressure of vacuum, and, in the case of the relative pressure, a pressure to be measured is registered referenced to a variable reference pressure, e.g. the ambient pressure. With differential pressure sensors, a difference between a first pressure and a second pressure, both acting on the sensor, is registered.

Independently of the type of pressure to be measured, common to all pressure measurements is that a pressure-measuring unit is provided, in which a pressure sensor, held in a housing, stands in contact with a medium whose pressure is to be registered. To the housing can be connected measuring diaphragms, dynamic pressure probes or flow orifices, or the housing itself can be mounted directly at the location of measurement, by means of a process connection formed on the housing.

Ceramic pressure sensors are especially well suited as pressure measuring cells. Ceramic pressure sensors exhibit a measurement accuracy, which is stable over a very long time. A reason for this is the strong, ionic bonding of ceramics, by way of which the material is very enduring and, in comparison to other materials, e.g. metals, practically does not age.

Depending on medium, components in contact with the medium must have a high chemical resistance. Moreover, they preferably can be used at high temperatures and should have a smooth, easily cleaned surface, which is, as far as possible, free of metal ions.

In the case of a ceramic pressure measuring cell, these requirements are fulfilled. Ceramic is a very robust material, able to withstand very high pressures and temperatures, as well as being highly chemically resistant.

The chemical resistance of the remaining components is frequently realized today by using, for instance in the case of the pressure pickup, very high-grade metals, e.g. tantalum, or metals coated with special, high-durability alloys, e.g. Hastelloy.

This does, it is true, give a highly chemically resistant surface; however, the requirement of freedom from metal ions is not fulfilled. Moreover, high-grade metals and special alloys are very expensive in comparison to simple steels.

Freedom from metal ions is achieved today by plastic coatings, e.g. coatings containing fluorothermoplastics, such as e.g. polytetrafluoroethylene (PTFE). Such plastics are, it is true, free of metal ions; however, they are only usable at relatively low temperatures, e.g. up to 150° C. Moreover, the allowable pressure range is also limited for these plastics, since they deform mechanically, if the pressure gets too high.

It is an object of the invention to provide a pressure measuring unit, which is as universally usable as possible.

To this end, the invention resides in a pressure measuring unit having
a ceramic pressure sensor held in a metal housing,
wherein the surfaces of the housing coming during measurement in contact with a medium, whose pressure is to be measured, are provided with a coating of enamel or a glassy material.

According to a first embodiment, the housing is a flange to be secured at a measurement location, the pressure sensor is built into the flange, and surfaces of the flange coming in contact with the medium at a measurement location are provided with a coating of enamel or a glassy material.

In a second embodiment, the housing has a process connection, and surfaces of the process connection coming in contact with the medium at a measurement location are provided with a coating of enamel or a glassy material.

In a third embodiment, the pressure sensor is a differential pressure measuring cell, the housing has two side flanges, between which the pressure sensor is clamped, and surfaces of the side flanges coming in contact with the medium at a measurement location are provided with a coating of enamel or a glassy material.

According to one embodiment, the housing is made of steel or stainless steel.

The invention and additional advantages will now be explained in greater detail on the basis of the figures of the drawing illustrating three examples of embodiments. Equal elements in the figures are provided with equal reference characters.

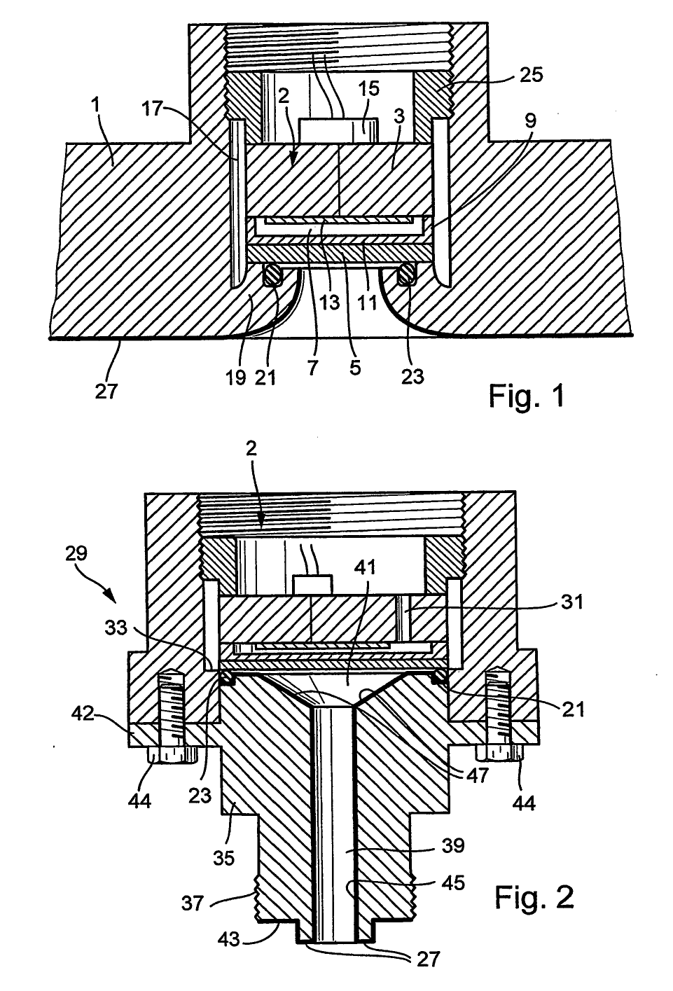

FIG. 1 shows a section through a pressure measuring unit of the invention having a pressure sensor held in a flange;

FIG. 2 shows a section through a pressure measuring unit of the invention having a pressure sensor held in a housing equipped with a process connection; and

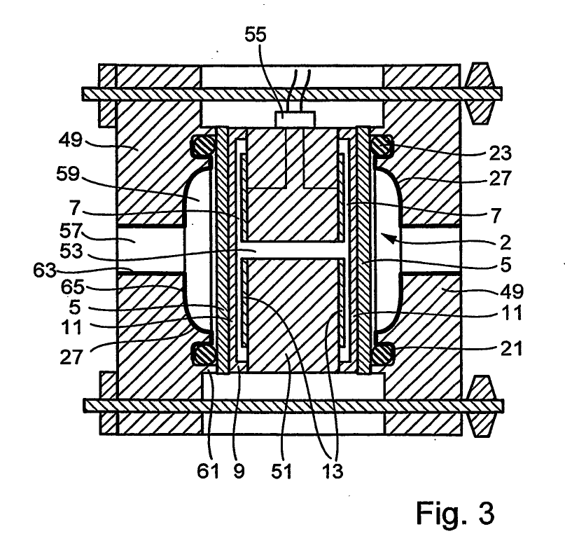

FIG. 3 shows a section through a pressure measuring unit of the invention having a differential pressure sensor held between two side flanges.

FIG. 1 shows a section through a first example of an embodiment of a pressure measuring unit of the invention.

The pressure measuring unit has a metal housing 1, in which a ceramic pressure sensor 2 is held.

The housing is made e.g. of a steel or a stainless steel, which are very cost-favorable compared to special materials.

The ceramic pressure sensor 2 is, in the illustrated example of an embodiment, an absolute pressure measuring cell composed of a platform 3 and a pressure sensitive membrane 5 arranged on the platform 3. The platform 3 is made of ceramic, e.g. of aluminum oxide (Al₂O₃). The membrane 5 can likewise be made of ceramic or e.g. glass or sapphire. The membrane 5 and the platform 3 are connected pressure-tightly and gas-tightly together along their edges by means of joint 9, to form a measuring chamber 7. Membrane 5 is pressure sensitive, i.e. a pressure p acting on it causes a deflection of the membrane out of its rest position.

The pressure sensor 2 includes a transducer for converting the deflection of the membrane 5 into an electrical, measured variable.

In the illustrated example of an embodiment of a capacitive pressure sensor 2, the transducer includes an electrode 11 arranged on an inner side of the membrane 5 and at least one counterelectrode 13 arranged on an oppositely-lying, membrane facing, outer side of the platform 3.

A capacitance of the capacitor formed by the electrode 11 and the counterelectrode 13 is established according to the deflection of the membrane 5 and is, consequently, a measure of the pressure acting on the membrane 5.

Electrode 11 and counterelectrode 13 are connected into a measuring circuit 15, which converts the capacitance into a pressure-dependent, output signal and makes such available for further evaluation and/or processing.

Instead of the described, capacitive transducer, other types of transducer can also be used. Examples of such transducers are strain gages or piezoresistive elements arranged on the membrane and connected e.g. to a Wheatstone bridge.

Likewise, a relative pressure measuring cell, or a differential pressure measuring cell could also, naturally, be provided here, instead of the absolute pressure measuring cell. An example of a relative pressure measuring cell is presented in FIG. 2, while FIG. 3 shows an example of a differential pressure measuring cell.

The housing 1 is a flange, in which the pressure sensor 2 is held. For this purpose, the flange exhibits an essentially cylindrical recess 17, an end of which has a shoulder 19 extending radially into the interior of the recess 17. Shoulder 19 is provided on its side facing into the interior of the recess 17 with an annular groove 21 for receiving a seal 23. Suitable as seal 23 is e.g. an O-ring of an elastomer. A plurality of seals can also be provided.

The pressure sensor 2 lies with an external, pressure insensitive edge of the membrane 5 on the seal 23. On an end far from the shoulder 19, a threaded ring 25 is screwed into the recess 17, to contact the membrane-far side of the platform 3 and press the pressure sensor 2 against the seal 23 and the shoulder 19.

According to the invention, all surfaces of the housing 1, that come in contact during the measurement with a medium whose pressure is to be measured, are provided with a coating 27 of enamel or a glassy material.

In the example of an embodiment illustrated in FIG. 1, along with an outer surface of the flange facing toward the measurement location, the surfaces of the shoulder 19 and the groove 21 come in contact with the medium and are, therefore, also provided with the coating 27.

FIG. 2 shows a section through a second example of an embodiment of a pressure measuring unit of the invention.

In this example of an embodiment, the pressure sensor 2 is a ceramic, relative pressure measuring cell, which is installed in a metal housing 29.

The relative pressure measuring cell differs from the absolute pressure measuring cell shown in FIG. 1 solely in that the platform 3 has a hole 31 passing through it. A reference pressure, against which the pressure to be measured is to be referenced, acts through the hole 31 onto a side of the membrane 5 facing the platform.

The housing 29 is essentially cylindrical and exhibits a bearing surface 33 extending radially into the interior of the housing 29. The pressure sensor 2 sits on bearing surface 33 with an outer, pressure-insensitive edge of the membrane 5.

Between the edge and the bearing surface 33 is a seal 23, e.g. an O-ring of an elastomer. Preferably, a groove 21 is milled into the bearing surface 33 for receiving seal 23.

The housing 29 includes a process connection 35, which serves for securing the process measuring unit at a location of use. The process connection 35 is formed by a section of the housing 29 located in front of the membrane 5 and having a smaller outer diameter. An external thread 37 is formed on the end of the process connection far from the membrane 5. By means of this thread 37, the pressure measuring unit can be secured at a measurement location (not shown in FIG. 2). Other types of securement, e.g. a flange connection, can likewise be used.

The process connection 35 has a central, axial, traversing bore 39, which opens to a chamber 41 in front of the membrane 5. The chamber 41 is bounded by the membrane 5, the process connection 35 and the seal 23.

A pressure p existing at the measurement location acts through the bore 39 and the chamber 41 on the membrane 5.

The process connection can be an integral part of the housing 29; it can, however, also be embodied as a removable part. This latter variant is illustrated in FIG. 2. There, the process connection 35 has a radially outwardly extending flange 42, through which screws are screwed into a cylindrical section of the housing 29 surrounding the pressure sensor, for the securement of the process connection 35.

Also in this case, per the invention, all surfaces of the housing 29 coming in contact with the medium are provided with the coating 27 of enamel or a glassy material. These surfaces are: an outer surface 43 of the process connection 35, reaching from the bore 39 to the external thread 37, a lateral surface 47 of the process connection 35 bounding chamber 41, the bearing surface 33 and the surface of the groove 21.

FIG. 3 shows a section through a third example of an embodiment of a pressure measuring unit of the invention. In this case, the pressure measuring unit is a differential pressure measuring unit having a ceramic differential measuring cell held between two side flanges 49.

The ceramic differential pressure measuring cell includes a platform 51, on whose mutually opposite end surfaces, in each case, a pressure-sensitive membrane 5 is arranged. Platform 51 is made of ceramic, e.g. aluminum oxide (Al₂O₃). The membranes 5 can, likewise, be made of ceramic or e.g. of glass or sapphire.

The membranes 5 and the platform 3 are connected pressure-tightly and gas-tightly together along their edges by means of joints 9, to form their respective measuring chambers 7. The two measuring chambers 7 are connected together via a bore 53 passing through the platform 51. The measuring chambers 7 and the bore 53 are filled with a liquid which is as incompressible as possible, e.g. a silicone oil. The membranes 5 are pressure sensitive, i.e. a pressure p acting on a membrane effects a deflection of the membrane 5 out of its rest position.

The differential pressure sensor includes a transducer for converting the pressure-dependent deflection of the membranes 5 into an electrical, measured variable.

In the illustrated example of an embodiment of a capacitive differential pressure sensor, the transducer in each case includes an electrode 11 arranged on an inner side of each membrane 5 and at least one counterelectrode 13 arranged on an oppositely lying outer surface of the platform 51 facing the respective membrane.

The capacitances of the capacitors formed by the electrodes 11 and the counterelectrodes 13 are established by the deflection of the membranes 5 and are, consequently, a measure for the differential pressure acting on the differential pressure sensor.

The electrodes 11 lie preferably at ground via the joints 9 and the counterelectrodes 13 are contacted through the platform 51 and are connected to a measuring circuit 55, which converts the capacitances into an output signal dependent on the differential pressure and makes such available for a further evaluation and/or processing.

The two side flanges 49 are essentially disks of rectangular cross section, which hold the pressure sensor such that the membranes 5 each face toward an end face of a side flange 49. Each side flange 49 has a traversing bore 57, through which, in each case, one of the two pressures whose difference is to be measured, acts on one of the membranes 5. At their ends facing the respective membranes 5, the bores 57 open into chambers 59 formed in the side flanges by recesses. The chambers 59 are surrounded at their edges on the end faces of the side flanges 49 by the bearing surfaces 61, against which the membranes 5 rest with an outer, pressure-insensitive edge, with interposition of at least one seal 23, e.g. an O-ring of an elastomer. Preferably, also in this case, grooves 21 are provided for seating of the seals 23.

According to the invention, in this case also, surfaces coming in contact with the medium at the measurement location, here lateral surfaces 63 of the bores 57, the surfaces 65 of the chambers 59, the bearing surfaces 61 and the surfaces of the grooves 21, are provided with a coating 27 of enamel or a glassy material.

With the presence of the coating 27, it is possible to use the pressure measuring units formed according to the invention at high pressures, high temperatures and/or in connection with media which are chemically highly aggressive. Since the durability of the pressure measuring units is determined by the durability of ceramic and of the coating, the housing itself can be made of a simple, coat-favorable metal.

All surfaces coming in contact with the medium are free of metal ions, since both the ceramic membranes 5 and also the coatings 27 are free of metal ions.

Additionally, the coatings 27 offer smooth surfaces, which are very easy to clean, and can withstand the high temperatures and/or pressures sometimes arising in cleaning procedures.

1-5. (canceled)

6. A pressure measuring unit, comprising:
a metal housing; and
a ceramic pressure sensor held in said metal housing, wherein:
the surfaces of said metal housing which come in contact with a medium, whose pressure is to be measured, during measurement, are provided with a coating of one enamel and a glassy material.

7. The pressure measuring unit as claimed in claim 6, wherein:
said housing is a flange to be secured at a measuring location;
said ceramic pressure sensor is installed in said flange; and
surfaces of said flange which come in contact with the medium are provided with said coating.

8. The pressure measuring unit as claimed in claim 6, wherein:
said housing has a process connection, and
surfaces of said process connection which come in contact with the medium at a measurement location are provided with said coating.

9. The pressure measuring unit as claimed in claim 7, wherein:
the pressure sensor is a differential pressure measuring cell;
said housing has two side flanges, between which said ceramic pressure sensor is clamped; and
surfaces of said side flanges which come in contact with the medium at the measurement location are provided with said coating.

10. The pressure measuring unit as claimed in claim 6, wherein:
said housing comprises steel or stainless steel.
